(19) United States
(12) Patent Application Publication
(10) Pub. No.: US 2016/0342743 A1
(43) Pub. Date: Nov. 24, 2016

(54) Incident Prevention System

(71) Applicants: Isaak E. van Kempen, Fremont, CA (US); William F. Wiles, San Jose, CA (US); Craig E. Bohn, San Jose, CA (US)

(72) Inventors: Isaak E. van Kempen, Fremont, CA (US); William F. Wiles, San Jose, CA (US); Craig E. Bohn, San Jose, CA (US)

(21) Appl. No.: 15/161,191

(22) Filed: May 20, 2016

Related U.S. Application Data
(60) Provisional application No. 62/164,527, filed on May 20, 2015.
(60) Provisional application No. 62/185,144, filed on Jun. 26, 2015.
(60) Provisional application No. 62/200,801, filed on Aug. 4, 2015.
(60) Provisional application No. 62/201,022, filed on Aug. 4, 2015.

(51) Int. Cl. G06F 19/00

(52) U.S. Cl. CPC G06F 19/322; G06F 19/3418

(57) ABSTRACT

A system monitor real-time conditions to assess pre-event variations from the norm in order to alert appropriate care-givers to provide timely care for the individual in order to avoid costly and life-changing events, with minimal disruption of life, which may be supported by an integrated system of devices to monitor a patient, including data storage and transfer devices, and a data management engine for assessing and handling the data according to instructions, so as to provide continual, real-time assessment of the individual's condition to provide optimally timed care with minimal disruption of life, including a microphone and camera array to detect incidents and capture varied degrees of visual data, depending on the perceived circumstances, including the capacity to obscure the identity of individuals detected in the video feed.

### CROSS-REFERENCE TO RELATED APPLICATIONS

This application claims the benefit of U.S. Provisional Application Ser. No. 62/164,527, filed on May 20, 2015, by the present inventors, entitled “Independence Enablement System,” U.S. Provisional Application Ser. No. 62/185,144, filed on Jun. 26, 2015, by the present inventors, entitled “Independence Enablement Network,” U.S. Provisional Application Ser. No. 62/200,801, filed on Aug. 4, 2015, by the present inventors, entitled “Incident Prevention System,” and U.S. Provisional Application Ser. No. 62/201,022, filed on Aug. 4, 2015, by the present inventors, entitled “Non-Invasive Monitoring System,” which are hereby incorporated by reference in their entirety for all allowable purposes, including the incorporation and preservation of any and all rights to patentable subject matter of the inventors, such as features, elements, processes and process steps, and improvements that may supplement or relate to the subject matter described herein.

### STATEMENT REGARDING FEDERALLY SPONSORED RESEARCH OR DEVELOPMENT

Not Applicable

### BACKGROUND OF THE INVENTION

This invention relates generally to the monitoring of physiological data specific to an individual, and more specifically to a system for collection, and remote monitoring, management and use of an individual's physiological data in order to detect changes in the individuals physiology of movement that indicate a likely future incident, in order to assess the reason for the change and address the reason in a manner that minimally disrupts the individual's life.

The field of physiological monitoring is crowded with devices that capture particular physiological data, and provide that data to the user. The user is then able to use the data to determine their current status and observe changes over a period of use. However, such devices do little to address the needs of populations that may need assistance with the assessment of the data, or with activity warranted by the information the data provides. It is very common for the current aging population to live remotely from the balance of their family, and many want to continue to live such independent lives. Currently marketed wearable devices do not provide customizable, detailed information to medical professionals, or family and friends located elsewhere. Current networking systems, based on technologies such as WiFi and Bluetooth® have limited range, creating a substantial expense to install a network to cover the likely places individuals want to go. Additionally, current systems do not assess the potential cause, determine the best entity to address the cause, and contact that entity to inform that entity of a change in the monitored individual. Alternatively, various cellular technologies require costly and complicated equipment and service plans many in the aging population do not want, and will resist using.

It would be an improvement to the field of art to have an assortment of devices linkable within a system having data storage, management, assessment, and intelligent distribution capabilities. It would also be an improvement to the field of art to have a resilient and dynamic network that supports an integrated system of devices to monitor an individual so as to provide continual, real-time assessment of the individual's condition to provide optimally timed care with minimal disruption of life. It would also be an improvement for the system to assess collected data and assess how best to address the situation, and contact the appropriate entity.

Such a network would improve a system that could assist in coordination of care for the individual with their medical professional, their immediate caregiver, and their family and friends, based on using real-time physiological data to anticipate likely incidents before they occur. Collected physiological data could include vital signs, such as pulse rate, cardiac pressure profile, oxygen concentration, and glucose levels, as well as location, body position, and any rapid movements that could indicate a stumble or miss-step. The network may help to enable the system assess the best entity to address the detected situation, and to selectively notify any desired combination of the individual, medical professional, immediate caregiver, and family and friends, as desired, once the devices indentify particular combinations of physical parameters, pre-events, or events.

It would also be an improvement to the art to have a system that permitted selective use of the camera to address potential concerns, thereby saving power and privacy. Additionally, it would be an improvement to the art to offer an active video-feed obscurance, which anonymizes the video feed. It would also be an improvement to the field to provide a camera that can present a view of the perspective of the patient, since they are not always technically capable, allowing them to enable selected people to view what they are viewing. Additionally, it would also be an improvement to the art to have the system link to a local display, so the monitored individual can monitor the live video stream and the obscured video stream, and to receive incoming videos from the individuals they permit to access their monitoring system, in order to easily share photos.

It would additionally be an improvement to the field for the network to easily identify and support communication with varied types of devices that may be employed as needed by the individual, to suit the individual's particular health and welfare concerns. Such a system and network would permit an individual to maintain a relatively independent life, while still monitoring and addressing their health and welfare needs. Such a system and network would also permit medical professional to better supervise the individual's care, and for friends and family members to stay informed on the status of their loved one, who may be remotely located.

### BRIEF DESCRIPTION OF THE DRAWINGS

FIG. 1 is a block diagram of an exemplary Incident Prevention System according to the present invention;

FIG. 2 is a movement chart showing an individual walking for 200 feet with a motion monitoring device;

FIG. 3 is a process flow diagram of an Incident Prevention System;

FIG. 4 is an alternate flow diagram of an Incident Prevention System;

FIG. 5 is a schematic illustration of the components of the audio/video device of the present disclosure;

FIG. 6 is a depiction of a still shot of an obscured video feed; and

FIG. 7 is a depiction of a still shot of an obscured MY VIEW™ feed.

### DESCRIPTION OF THE PREFERRED EMBODIMENT

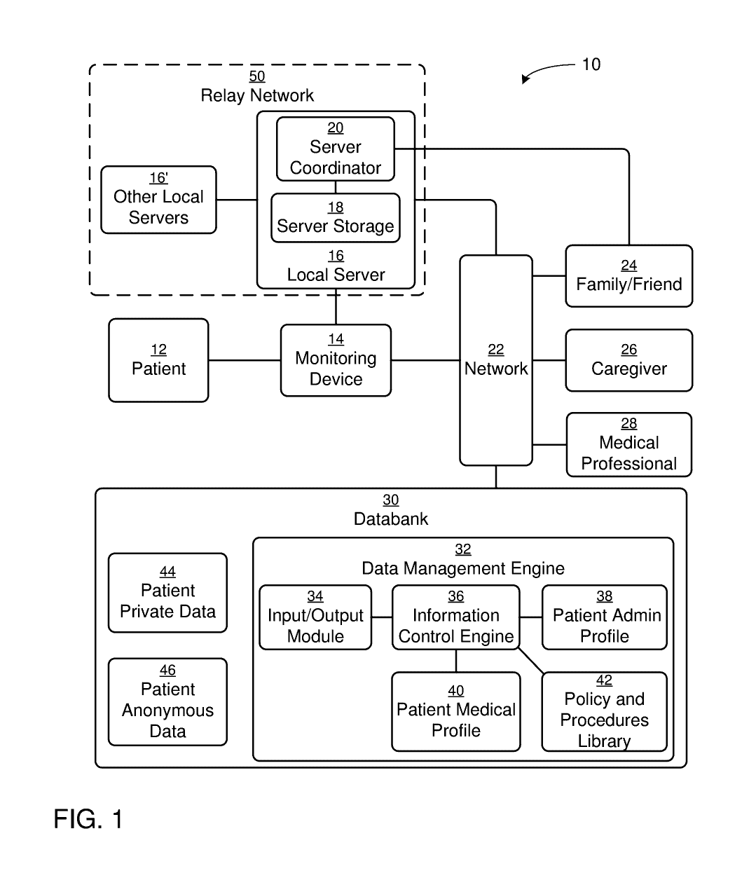

An exemplary incident prevention system 10 and process will now be described in detail with reference to FIG. 1 of the accompanying drawings. The embodiment of incident prevention system 10 (hereinafter “IP system”) is shown in FIG. 1, which include a patient 12, at least one monitoring device 14, a local server 16, a network 22, and an exemplary databank 30.

In the exemplary embodiment, the monitoring device 14 may sense conditions pertaining to the patient 12 or the patient's surroundings. The exemplary monitoring device 14 may have at least one sensor, storage capacity, and the communication capacity. Exemplary sensors may include those that collect physiological data including vital signs, such as pulse rate, cardiac pressure profile, oxygen concentration, and glucose levels, as well as location, body position, movement patterns, and any rapid movements that could indicate a stumble, miss-step, or fall. Additionally, sensors may include environmental sensors to detect medication access, access and use of appliances, security system status, ambient temperature, and smoke, fire and carbon monoxide detection, to name a few examples. In the exemplary embodiment, data from the sensors may be stored in the storage capacity inherent to the monitoring device 14. The data may then be transferred to the local server 16 at appropriate times, though the storage capacity of the monitoring device 14 may be adequate to store over a day of data. In the exemplary embodiment, the communication capacity may be a variety of means, which may include Bluetooth®, WiFi, 802.11x wireless local area network, RF signals, GSM and 3G/4G, and next generation, telecommunication technology.

A set of sensors in the exemplary embodiment of the monitoring device 14 may be a tri-axis acceleration sensor, a tri-axis gyroscope sensor, a tri-axis geomagnetic sensor and GPS. These combined location sensors may be able to track the individual for extended periods of movement without the sustained use of GPS, which uses substantial power. Once a precise position is established, which may be by GPS, the location sensors track the patient's 12 movement from that known point. Exemplary movement tracking may include altitude and elevations, as well as longitude and latitude. This may enable the monitoring device 14 to ascertain which floor of a building the patient 12 may be on. In addition to turning on a GPS within the monitoring device 14, a GPS location may be transferred to the monitoring device 14 from a co-located cell phone or smartphone, the longitude and latitude may be entered manually, or RFID tags may be placed at known locations for the monitoring device 14 to detect, such as at the entrance of the patient's 12 room or domicile.

The exemplary local server 16 may have server storage 18 in which to collect and hold the incoming data from the monitoring device 14. The local server 16 may also have a server coordinator 20, which includes a computer processor for receiving and executing computer readable instructions saved in server storage 18. As such, the server coordinator 20 may accept and direct the flow of data from the monitoring device 14 into the server storage 18.

The exemplary server coordinator 20 may assemble and transfer data to the databank through network 22. The exemplary server coordinator 20 may provide select information directly to the family/friend 24, which information may include status and operational information on the device 14 and local server 16, as well as other components of the IP system 10. It may be envisioned that the family/friend 24 may be the person that administers the IP system 10 for the patient 12. The exemplary server coordinator 20 may control security protocols and permit administration of the IP system 10. Administration of the IP system 10 may include setting up the unit, programming preferences and instructions, and coordinating permissions and authorizations that may be required to appropriately maintain security of the patient's data and care.

In the exemplary embodiment, the network 22 may primarily enable data transfer from the local server 16 to the databank 30. Additionally, the network 22 may provide a link from the databank 30 to various individuals to whom the patient may want certain information to be sent, including loved-ones, family, and friend 24, a caregiver 26, and a medical professional 28. Additionally, the network 22 may provide a link from the monitoring device 14 to the databank 30. With a number of possible communication configurations, the monitoring device 14 may transmit a signal directly to a party who can act on the information the monitoring device 14 provides, including loved-ones, family, and friend 24, a caregiver 26, and a medical professional 28. An appropriate network 22 may include the Internet and the World Wide Web, but also may include cellular telephone, radio, and other technology communication networks.

In the exemplary embodiment, the databank 30 may host the data management engine 32 (hereinafter “DM engine”), which may accept, store, and execute instructions for the management and use of the data collected by each of the monitoring devices 14 for a particular patient 12. The exemplary DM engine 32 may have a number of components, which may include an input/output module 34, an information control engine 36, a patient administrative profile 38, a patient medical profile 40 and a patient's policy and procedures library 42. In the exemplary embodiment, the information control engine 36 may be the primary component that coordinates the function and operation of the other components. The exemplary information control engine 36 may be a computer processor that can be programmed to store data, manage data, create information from the data, and controllably distribute data and information derived from the data. The exemplary information control engine 36 may affect distribution of data and information via the input/output module 34, which may be the DM engine 32 component for receiving and transmitting data via the network 22.

The exemplary information control engine 36 may receive, store, and comply with instructions and authorizations established by the patient 12, or their appropriately designated agent or legal authority. Once duly authorized, the information control engine 36 may accept information and instructions on how to use and manage the patient's data from those duly authorized users, which may include the patient 12, a family member or friend 24, a caregiver 26, and a medical professional 28. Data and information pertaining to the patient's administration of the system may be stored in the patient administrative profile 38. Data and information pertaining to the patient's medical records and medical conditions may be stored in the patient medical profile 40. Data and information that establishes the policies and procedures for appropriately handling the patients' data and information may be stored in the patient policy and procedures library 42. The exemplary information control engine 36 may use information held in the patient administrative profile 38, and a patient's policy and procedures library 42 to appropriately handle, analyze, and distribute data and information held in the patient medical profile 40.

In the exemplary embodiment, the information control engine 36 may identify and segregate patient private data 44 and patient anonymous data 46 in the databank 30. Patient private data 44 may include all the data collected about the patient 12 from which the patient 12 may be identified. As such, patient private data 44 may warrant special safeguards to ensure it is handled and secured from inappropriate release properly. Patient anonymous data 46 may include extensive amounts of the data collected about the patient 12, but which data has been stripped of elements that would connect it to a specific patient 12. As such, if the patient anonymous data 46 were to be captured outside the IP system 10, no one would be able to relate the data back to a specific patient 12.

In the exemplary embodiment, the databank 30 may have the capability to collect and manage data for multiple patients 12, individually maintaining each patient's data secure and apart from the others, and administering use of the particular patient's data according to the particular instructions for that particular patient 12.

The exemplary embodiment also includes a relay network 50, which may be created by a local server 16 interfacing with at least one other local server 16′. The relay network 50 may be created by using a choice of communication means open and available to the local server 16 and the other local servers 16′, to include Bluetooth®, WiFi, 802.11x wireless local area network, RF signals, GSM and 3G/4G telecommunication signals.

In the exemplary embodiment of relay network 50 RF signals may be used to create a network blanketing many square miles. A suitable network may be based on an RF signal in the 800-900 MHz ranges, which has shown to provide reliable communication over a mid-range distances (about 1 mile), in varied types of terrain. These UHF ranges, typically referred to as either the 900 MHz or 33-centimeter band, are highly effective in mid-range communication, require special no licensing, and are easily adaptable for signal repeater applications, where one narrower subset range of frequencies are dedicated to transmit (output) and receive (input). As long as the local server 16, and any other local server 16′ is within that effective range of another local server 16′, effective communication may be achieved and maintained.

In this fashion, data from a specific monitoring device 14 may be relayed to its respective local server 16 as long as the monitoring device 14 is linked to that local server 16 through the relay network 50 of mutually linked other local servers 16′. Each exemplary monitoring device 14 may be coded to identify and find the respective local server 16. In the exemplary IP system 10, a monitoring device 14 may be able to make urgent, high priority, or emergency transmissions directly from an other local server 16′ located near the monitoring device 14. This relay network 50 may be especially useful in areas that lacks established Wifi network coverage. It is also useful that the relay network 50 may be on a dedicated network that avoids bandwidth competition with other systems. Additionally, various encryption and security means may be employed on the monitoring device 14, various transmissions, local servers 16, across the network 22, and within databank 30.

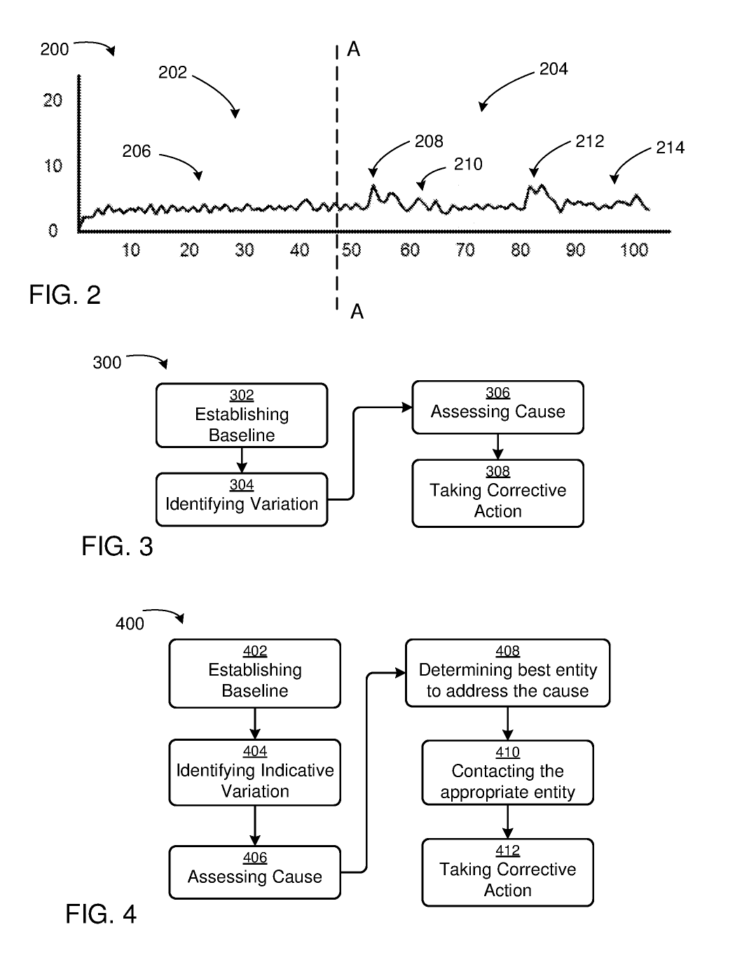

Referring now primarily to FIG. 2, movement chart 200 shows an exemplary walking motion of an individual, as monitored by a monitoring device 14, and captured by a local server 16. The movement chart 200 shows 200 feet of walking activity, separated at line A-A into the baseline section 202, and the observation section 204. During the baseline section 202 the individual is observed to exhibit a normal stride pattern 206. However, the individual exhibits a stumble pattern 208 and then a recover pattern 210 early on in the observation section 204. Shortly thereafter the individual experiences a more sustained stumble or miss-step pattern 212, which is continued by an irregular stride pattern 214.

Referring now primarily to FIG. 3, a process flow diagram of an IP system 10 may include establishing a baseline 302, identifying a variation 304, assessing the cause 306, and taking corrective action 306. Establishing a baseline 302 may include the initial data collection from one or more monitoring devices 14, such as the data collected in baseline section 202. In the exemplary embodiment, the data on stride activity may be transferred to the local server 16, captured in the server storage 18, and reviewed and assessed by the server coordinator 20. The review of the data may then identify a variation 304 that could indicate a likely future adverse incident by comparing a normal stride pattern 206 to the currently detected stride pattern. As data is compiled the system may be continually improved to better detect variations that indicate likely future events. A stumble pattern 208 could be identified as a variation, and the server coordinator 20 would follow its instructions to contact the appropriate entity likely to address the type of incident. In this example, a single stumble could be simply noted and communicated to a family member 24, who could do a preliminary assessment of the cause 306. But, if, for instance, this were a repeat occurrence, the IP system 10 could notify the individual's medical professional 28. The medical professional 28 would assess the cause 306. The assessment would then determine appropriate corrective action, and such corrective action could then be taken 308. Examples of potentially suitable corrective action may include physical therapy, neurological assessment, assessment of the patient's eyewear, or assessment of the patient's footwear. The objective is to address and correct the irregular stride pattern 214 in order to avoid a likely future catastrophic incident.

Referring now primarily to FIG. 4, an alternate process flow diagram of an IP system 10 may include establishing a baseline 402, identifying an indicative variation 404, assessing the cause 406, determining the best entity to address the cause 408, contacting the appropriate entity 410, and taking corrective action 412. Establishing a baseline 402 includes the initial data collection from one or more monitoring devices 14, such as the data collected in baseline section 202. In the exemplary embodiment, the data on stride activity may be transferred to the local server 16, captured in the server storage 18, and reviewed and assessed by the server coordinator 20. The review of the data may then identify a variation 404 that could indicate a likely future adverse incident by comparing a normal stride pattern 206, as well as other historical stride patterns, to the currently detected stride pattern. As additional historic and experiential data is compiled the system may be continually improved to better detect variations that indicate likely future events. A stumble pattern 208 would be identified as a variation. The server coordinator 20 would then determine the best entity to address the cause 408, which could include following the patient's 12 and medical professional's 28 instructions to contact the appropriate entity likely to address the type of incident. In this example, a single stumble could be simply noted and contacting the appropriate entity 410 could be communicated to a family member 24, who could do a preliminary assessment of the cause 306. But, if, for instance, this were a repeat occurrence, contacting the appropriate entity 410 for the IP system 10 could result in notifying the individual's medical professional 28. The medical professional 28 would assess the cause and determine appropriate corrective action, and such corrective action could then be taken 412. Examples of potentially suitable corrective action may include physical therapy, neurological assessment, assessment of the patient's eyewear, or assessment of the patient's footwear. The objective is to address and correct the irregular stride pattern 214 in order to avoid a likely future catastrophic incident.

The IP system 10 may be employed in a care facility situation where a patient may begin monitoring prior to discharge. Establishment of a baseline 302 could then happen in a controlled environment. Identifying variations 304 could then be indicators of such things as whether the patient filled their prescription, is actively and appropriately taking their prescription, are attending subsequent follow-up appointments with their medical professional 28, either their primary care physician or specialist, and whether their basic physiological readings are staying within the norms their medical professional 28 finds appropriate. By monitoring these things, the medical professional 28 may be able to substantially improve the patient's 12 likelihood of readmission to the medical care facility.

The system could include an interface with the doctors scheduling system, so that appointments made with the patient 12 could be monitored and confirmed by the IP system 10. Once an appointment is made the IP system 10 monitors the patient's 12 travel activity surrounding the time, and determines at what point the patient 12 may have likely forgotten or may not be able to make their appointment. Such monitoring could detect that the person has not gotten out of bed, or has not left their house in a timely manner for their appointment. Is such situation, the IP system 10 could notify the medical professional's office, and a prompting call could be made to the patient 12. Similarly, monitoring device 14 may include a prescription monitoring device that documents the patient's 12 medication, assesses the appropriate consumption of those medications, reminding the patient 12, to take medications, according to the patient's 12, family/friend's 24, caregiver's 26, or medical professional's 28 instructions.

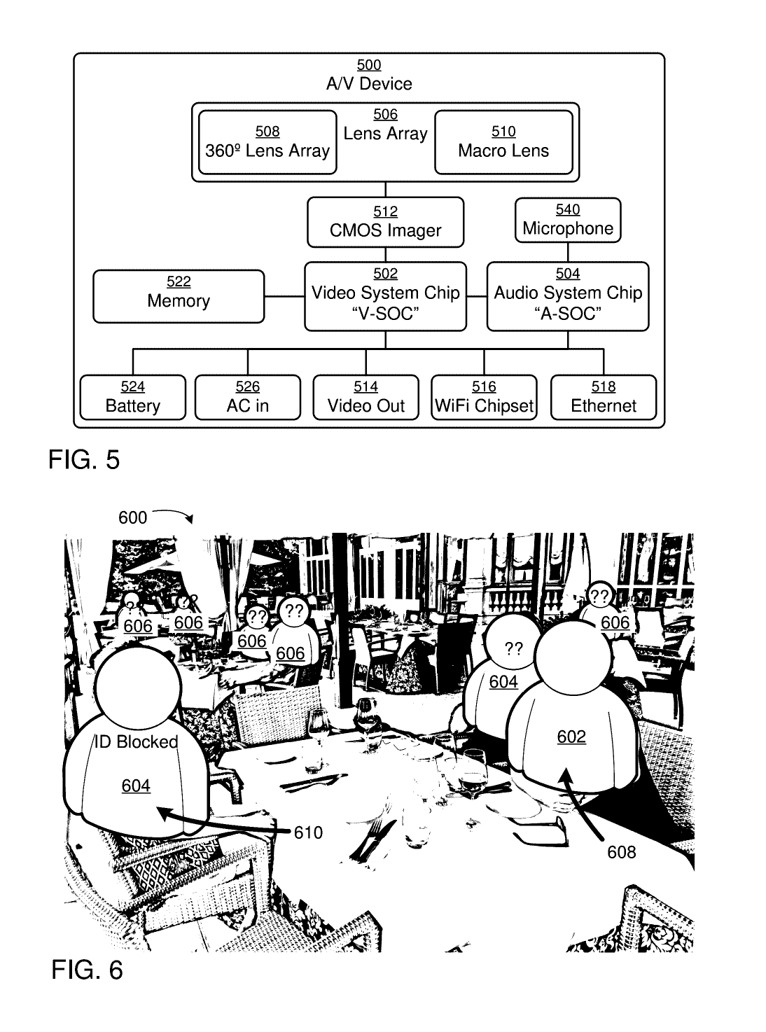

Referring now primarily to FIG. 5, an exemplary audio/video device 500 is shown to demonstrate the types of components a suitable device may have to support the current system. The A/V device 500 may have both a video system-on-a-chip (“V-SOC”) 502 and an audio system-on-a-chip (“A-SOC”) 504 to control the operation and function of the audio and video systems. The V-SOC may be linked to a variety of lenses in lens array 506, including a 360° lens array 508 and a macro lens 510. In the exemplary embodiment, the images from the lenses are processed through CMOS imager 512.

The A/V device 500 may be connectable to the local server or a display through the video out outlet 514. The A/V device 500 may connect directly to a WiFi or 802.11x wireless network with the WiFi chipset 516. The A/V device 500 may connect directly to an Ethernet with an Ethernet plug 518. The A-SOC may have an independent or integral microphone 520. And both the V-SOC and A-SOC may be supported by inherent memory 522, which may be flash memory, such as NAND, or other suitable fast-response, stable memory. Additionally, the A/V device 500 may be powered by either a DC connection from a battery 524, or an AC connection through the AC in plug 526.

Referring now primarily to FIG. 6, an example is provided of a video feed output 600. This video feed output 600 may be accessed over the Internet, by an authorized user, or it may be displayed by the patient 12 through an attached display. A display may receive the signal from the video out plug 514 on the A/V device 500. The feed 600 is shown in obscure mode, though the patient 12 may be able to easily turn on the live feed without obscuration.

In the exemplary embodiment, the patient is identified by the system and shown as a patient avatar 602. The exemplary patient avatar 602 may be shown as colored green 608 to depict that a specified group of parameters monitored by the system are in acceptable ranges and levels. The avatar 602 color may be changed to depict varying degrees of the patient 12 being out of the norm or targets, which may include yellow, orange, and red. Two guest avatars 604 are shown in the picture. One may be shown as “ID Blocked,” while the other may be shown as unknown by the system with a “??” annotation. The “ID blocked” guest avatar may be depicted in a yellow color 610. Color may be used to show the potential degree of threat or hostility the particular individual poses to the patient 12, or the color may be used to depict their general health condition. The yellow color 610 in the example may be used to depict that this guest has been talking and gesturing in an elevated manner, and may pose a low degree of threat to the patient 12. The monitoring system 10 identifies other individuals in the feed, and marks them with miscellaneous individual avatars 606. In the exemplary embodiment the miscellaneous individual avatars 606 may have also been noted as unidentified. The system may be set to identify all individuals in the shot, or only those in a set proximity to the patient 12.

During the principle time of operation the V-SOC may operate on an extremely low frame rate, in order to save energy and memory, and to not be intrusive. However, upon the detection of an event, such as a loud noise, glass break, gun shot, unidentified dog bark, shout for “help,” or distressed sound, to name a few, the A/V device 500 may active in full definition mode, and coordinate with the local server 16 to determine if further action is suitable.

The system permits the local server 16 to capture and analyze the A/V device 500 feed for supplemental physiological information. Software may be used to detect the patient's temperature, blood pressure, pulse, or other physiological vital signs. Additionally, the local server 16 may process the images for changes in the environment, such as furniture or photo being moved, and highlight those to an authorized user. Additionally, the computing power of the local server 16 may be used for other analysis of the video stream that becomes possible as software and sensor 16 technology improves.

The A/V device 500 may be hardwired to the local server 16, or may be battery powered and located places that would present a wiring challenge. In the exemplary embodiment, it may be envisioned that a small living area could be covered by a small number of cameras, potentially attached to the walls. Using a removable adhesive, such as 3M's Command™ brand damage-free hanging devices could permit installation in a wide variety of locations and surfaces, without causing damage to the surface.

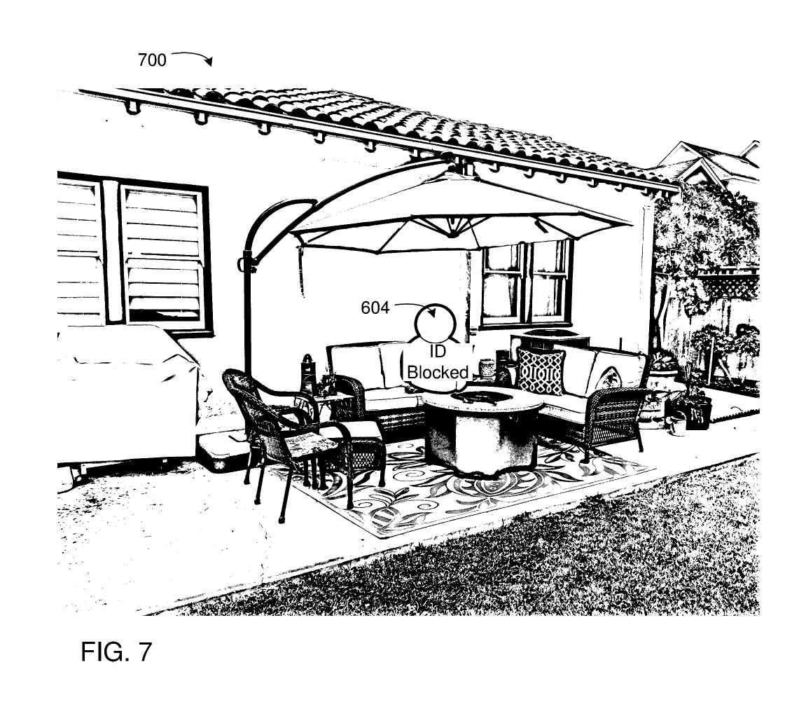

Referring now primarily to FIG. 7, an example is provided of a MY VIEW™ feed 700. The A/V device may be attached to the chest of the patient 12, or carried, in order to show others with authorized access what the patient 12 is viewing. In the exemplary feed 700 a guest 604 may be present. The obscuration function may be employed on the MY VIEW™ feed 700, or a live, unobscured feed may be permitted.

Similarly, authorized users may be permitted to load images in to either the local server storage 18 or the A/V device memory for display on a display the patient 12 can view. The system would allow the authorized user to control the viewing experience, in order to take the burden off the patient.

The foregoing disclosure and description of the invention is illustrative and explanatory thereof. The examples contained in this specification are merely possible implementations of the current system, and alternatives to the particular features, elements and process steps, including scope and sequence of the steps may be changed without departing from the spirit of the invention. In addition to those described, many additional monitoring devices may be enabled into the integrated system created by this IP system 10. The present invention should only be limited by the examined and allowed claims, and their legal equivalents, since the provided exemplary embodiments are only examples of how the invention may be employed, and are not exhaustive.

I claim:

1. A system for monitoring real-time conditions pertaining to a patient, comprising:
a patient monitoring device;
at least one local server configurable to be in communication with the patient monitoring device;
a communication network creating a communication channel between the at least one local server and caring individual;
a databank in communication with the communication network; and
said databank configured to store and manage patient information.

2. The system of claim 1, further comprising:
at least one additional local server configurable to be in communication with the at least one local server and the communication network.

3. A process for monitoring real-time conditions pertaining to a patient including a computer to execute process instructions, the process comprising:
establishing a patient's baseline status of at least one physiological parameter with a patient monitoring device, at least one local server configurable to be in communication with the patient monitoring device, a communication network creating a communication channel between the at least one local server and caring individual, a databank in communication with the communication network, and said databank configured to store and manage patient information;
identifying indicative variation of the at least one physiological parameter;
assessing the cause of the variation; and
taking corrective action to address the variation by contacting a caring individual with the communication network.

4. The process of claim 3, further comprising:
determining a best caring individual to address the variation; and
contacting the best caring individual and providing information on the variation.
